(19) United States
(12) Patent Application Publication
(10) Pub. No.: US 2026/0239523 A1
(43) Pub. Date: Aug. 13, 2026

(54) ELECTRIC FIELD INTENSIFYING STRUCTURE

(71) Applicant: Daphne Technology SA, Ecublens (CH)

(72) Inventors: William Jamieson Ramsay, Ecublens (CH); Juan Mario Michan, Ecublens (CH); Anders Olsson, Ecublens (CH); Seyedehbehnaz Varandili, Ecublens (CH); Anastasios Charitopoulos, Ecublens (CH)

(73) Assignee: Daphne Technology SA, Ecublens (CH)

(21) Appl. No.: 19/154,679

(22) PCT Filed: Feb. 7, 2024
(86) PCT No.: PCT/EP2024/053017

§ 371 Date: Aug. 7, 2025

(30) Foreign Application Priority Data
Feb. 8, 2023 (EP) 23386009.7

(51) Int. Cl. H05H 1/24

(52) U.S. Cl. CPC H05H 1/2431

(57) ABSTRACT

The disclosure provides a structure for electric field intensification for use in a dielectric barrier discharge device. The structure comprises: a ring including at least one tip, the tip extending along a first radial axis passing through the centre of the ring, wherein in use, the ring is arranged around a first electrode of a discharge device, there being a gap between the structure and an opposing electrode of the discharge device, the at least one tip limiting a minimum gap between the structure and the opposing electrode, thereby increasing a probability of an electric breakdown occurring at the tip when an electric field is applied between the first electrode and the opposing electrode.

### FIELD OF THE INVENTION

The present disclosure relates to devices for pollutant abatement of components of gas or air by exposure to electrical discharge. This is achieved through use of an electric field intensifying structure for use in a dielectric barrier discharge device. The electric field intensifying structure promotes electric field breakdown at discrete locations.

### BACKGROUND

As a result of increasing global concern regarding pollutant emissions from the use of fossil fuels and other processes, which contribute to poor air quality, environmental damage, and harm to human health, there is an increased focus on air quality and emissions regulations. There is therefore a need to provide means to eliminate or reduce the concentration of pollutant emissions into the atmosphere.

Hydrocarbons represent one pollutant where it is desirable to minimize or eliminate release into the atmosphere. In particular, there is a desire to minimize methane (CH4, CH₄) emissions because methane is a potent greenhouse gas and, as such, is of concern due to its contribution to rising global temperatures. Methane has a shorter atmospheric lifetime than carbon dioxide (CO2, CO₂) over the established periods presented by the Intergovernmental Panel on Climate Change (IPCC), which are 20 years, 100 years and 500 years, and the importance of methane is relatively high in a shorter time frame (IPCC 2013).

In recent years, liquefied natural gas (LNG), which has methane as its main component, has attracted attention as an alternative fuel to petroleum and light oil, and has been used as a fuel to power engines, for example, on ships. From an air quality perspective, LNG fuel has many advantages compared to traditional (marine) fuels. The emissions of sulphur dioxide (SO2, SO₂) are low due to low or non-existing sulphur content of the gas. The low sulphur content and the absence of fuel aromatics also contributes to low particulate formation levels.

Further, the most widely used marine LNG engines have significantly less emissions of nitrogen oxides (NOx, NOₓ) than the traditional marine diesel engines.

Although LNG engines are expected to be a relatively clean alternative fuel that can realize low-pollution, many LNG engines that are produced today have problems with unburned methane passing through the engine and being emitted with the exhaust gases. This so-called “methane slip” has been estimated at around 2.3% to 4.1% for the engines that are in operation today (Stenersen and Thonstad, 2017). The quantity of this slip has caused LNG to be comparable to or worse than marine gas oil (MGO) for greenhouse gas emissions, measured as CO₂-equivalents (Pavlenko et al., 2020; Winnes et al., 2020).

The use of LNG as a marine fuel has increased significantly over the last two decades. In 2010, 1.4% of the delivered ships were built for LNG-propulsion. This share increased to 5.7% in 2017 and further to 13.5% by 2018 (Le Fevre, 2018). Factors that have influenced this development were, and are, regionally stricter rules for ship emissions of sulphur and nitrogen oxides, and a relatively low price for LNG compared to MGO.

Due to the detrimental impact of unburned methane from LNG engines on the environment, climate, and human health, and in consideration of its increased use in the last decade, it is desirable to purify exhaust gas, removing methane before it is released into the atmosphere.

There is on-going development at engine manufacturers to reduce the methane slip from LNG engines, and although the work has been moderately successful since the problem was first observed, there appears to be a limit for slip reduction by engine design measures (Pavlenko et al, 2020). Thus, other post-engine methods are needed to eliminate methane slip.

Typically, hydrocarbons (including methane) are removed using catalysts such as platinum, palladium, or rhodium at high temperatures or by adsorption methods. Methane is a relatively stable molecule and so traditionally requires temperatures of at least 400 degrees Celsius (° C.) over a precious metal-based catalyst to oxidise.

The paper “Characterisation and Evaluation of Methane Oxidation Catalysts for Dual-Fuel Diesel and Natural Gas Engines”, Emission Control Science and Technology (2016) 2, p 204-214, discloses low temperature removal of methane from exhaust gases at temperatures under 400° C. using catalysts with high loadings of platinum and palladium (up to 340 grams per cubic foot, g/ft³, 12,000 grams per cubic metre, g/m³).

In addition, palladium-based catalysts are sensitive to SO2 and deactivate at very low concentrations of SO2 in the exhaust stream. High concentrations of CO2 and H2O in exhaust gases are also known to limit the activity of (methane) oxidation catalysts.

There remains a need for methane slip removal processes that circumvents the limitations of precious metal-based catalyst materials.

A catalyst-free technology used for treatment of flue emissions from fossil fuel burning facilities (such as power stations) and from municipal solid waste burning incinerators is electron beam flue gas treatment (EBFGT). EBFGT removes sulphur oxides (SOx, SOₓ) and NOx from stack gases (i.e. gases passing through an exhaust stack) at low energy cost by conversion with ammonia (NH3, NH₃) to non-noxious ammonium sulphate-nitrate, usable as an agricultural fertilizer. This technique involves humidified flue gases passing through an electron beam reactor where high-energy electrons bombard nitrogen, water and oxygen to create strong reagents that react with the sulphur oxides and nitrogen oxides to form sulphuric and nitric acids.

In EBFGT, the electron beam reactor is formed by a bank of electron beam accelerators, specifically double-grid tetrode electrode guns in which the cathode housing is located in a vacuum housing. Free electrons are produced in an ultra-clean environment (referred to as ultra-high vacuum) where the pressure is around 12 orders of magnitude lower than atmospheric pressure. The electrons are then accelerated and sent through an aluminium or titanium membrane that separates the ultra-high vacuum environment from the flue stack were the pollutant gases are flowing. The electrons that get through the aluminium membrane collide with the gas molecules and start a chemical chain reaction that removes the pollutants.

Implementations of such EBFGT systems require very large capital costs due to the electron accelerator installation. The electron accelerators also require frequent maintenance and extreme safety requirements, which is undesirable or not possible in the location in which the reactor is installed. Further, multiple accelerators must be implemented for redundancy purposes.

The need for an ultra-high vacuum adds expense and can contribute to accelerator failures. Additionally, using this technology for mobile applications is undesirable because the radiation shielding needed to protect against at least X-ray emission and ionization radiation is heavy.

There remains also a need for methane slip removal processes that circumvents the limitations of EBFGT systems.

In electric discharge devices, such as dielectric barrier discharge devices, high-energy electrons are produced during electrical discharge. In state-of-the-art electric discharge devices, there is a uniform (i.e., homogenous) volumetric distribution of electrical discharges that produce electrons with a distribution of energy typically between 1-10 electron volts (eV). However, this yields low methane removal efficiency and can be improved.

In view of the above circumstances, a practical means for exhaust gas purification apparatus capable of favourably oxidizing unburned components (such as methane) of a gas fuel (such as LNG) is needed.

### SUMMARY OF INVENTION

An aspect of the disclosure provides a structure for electric field intensification for (i.e. suitable for) use in a dielectric barrier discharge device, the structure comprising: a ring including at least one tip, the tip extending along a first radial axis passing through the centre of the ring, wherein in use, the ring is arranged around a first electrode of a discharge device, there being a gap between the structure and an opposing electrode of the discharge device, the at least one tip limiting a minimum gap between the structure and the opposing electrode, thereby increasing a probability of an electric breakdown occurring at the tip when an electric field is applied between the first electrode and the opposing electrode.

The provided structure for electric field intensification provides various benefits in terms of increasing the efficiency at which a discharge device, for example a dielectric discharge device, removes pollutants from exhaust gas. In use, the ring, and by extension, the structure is arranged around a first electrode in such a way that a gap is formed between an opposing electrode and the structure. The presence of the structure introduces asymmetry in an electric field applied between the first and opposing electrodes. This leads to a higher concentration of active species near the structure relative to a conventional discharge device. The structure therefore promotes oxidation of a gas passing through the discharge device in use. Specifically, the radially extending tip reduces the gap between the structure and the opposing electrode at the location of the tip. This concentrates the applied electric field at the tip. This increases the production of active species at the tip, and so gas in the vicinity of the tip is therefore more likely to be oxidised.

Further, because of the inherent geometry of the tip, that is, because the tip typically terminates in a sharp point, the tip assists in the formation of plasma streamers when a pollutant is passed through a discharge device in use.

It has been observed that in use, a discharge device including such a structure removed pollutants at a higher efficiency compared to a similar device without the structure.

All of these benefits are achieved without the need to provide any extra energy. That is, the electric field usually applied to a conventional discharge device can be applied to a staged device with a structure to provide an improved efficiency of pollutant removal.

Furthermore, no catalyst is required to achieve an improved rate of pollutant removal. If a catalyst were to be used, this would still provide a further improvement, but a catalyst is not required.

In a further optional example, the electric field intensifying structure further comprises a channel extending from the centre of the ring to the exterior of the ring along a second radial axis, wherein the second radial axis is not aligned with the first radial axis.

A width of the channel may be 1 millimetre (mm) in some optional examples.

The presence of a channel facilitates easy installation and removal of the structure around the first electrode. This effectively makes it easier to replace a structure, for example if it becomes faulty. The width of the channel also provides room for the structure to expand and contract, for example due to being heated up by the gas flowing through the discharge device in use. This further improves the reliability of the structure.

In some examples, the ring has a main body, and the at least one tip is connected to the main body.

In some advantageous examples, the main body may have a radial thickness of 3.6 mm.

The radial thickness of the ring increases the structural integrity of the structure. For example, the structure is less likely to be bent out of shape.

The ring having a radial thickness of 3.6 mm provides an optimum trade-off between structural strength and ensuring that the structure is not overly large.

The electric field intensifying structure of any preceding claim, wherein the at least one tip comprises two sides meeting at a point, a first angle being formed between the two sides to form the tip.

Additionally, the first angle may be 69 degrees.

This is optimal for pollutant removal, such as methane, in use. Further, this angle ensures that the tip has a minimum level of structural integrity. A tip with a first angle of at least 69 degrees is less susceptible to breaking than a sharper tip. The specified first angle may also allow the tip to be easily repeatably manufactured with a high level of accuracy and precision.

In advantageous examples, the at least one tip of the electric field intensifying structure comprises a plurality of tips, each tip in the plurality of tips being arranged on the outer edge of the ring.

A plurality of tips may provide further improvements to the efficiency of pollutant removal in use. That is, a plurality of tips provides additional sites for electric breakdown of gas to occur. This evidently means that more gas can be treated compared to if the structure has a single tip.

In some further examples, the plurality of tips may each extend along a respective radial axis not aligned with the second radial axis.

This effectively means that each of the plurality of tips extends along a different radial direction. This is intended to mean that the tips will be distributed to some extent on the outer edge of the ring. The effect of the tips is therefore less likely to overlap with each other, and therefore the tips complement each other. That is, in use, the tips each encounter a different part of the gas flowing through the discharge device.

Moreover, it is advantageous for the plurality of tips to be uniformly distributed on the outer edge of the ring in some examples.

A uniform distribution of the tips provides further improvements to the efficiency of pollutant removal in use. By requiring a plurality of uniformly distributed tips, it is ensured that each part of the gas flowing through the discharge device in use has some chance to be treated.

Note that by uniformly distributed we intend to mean that the tips are uniformly distributed around the material of the ring, rather than the full 360 degrees of the structure. For example, a channel may provide a break in the ring.

In some examples, the plurality of tips may comprise 3 tips.

In other examples, the plurality of tips may comprise 21 tips.

A particular number of tips may be effective for removing a pollutant in use.

The plurality of tips may typically comprise 6 tips in certain advantageous examples.

The plurality of tips may also consist of 6 tips,

A structure with 6 tips has been found to be optimal for removal of a pollutant, such as methane, from gas flowing through the discharge device in use.

The second radial axis may bisect a second angle between two adjacent tips on either side of the channel, the first angle being measured between adjacent sides of the two tips.

The electric field intensifying structure of claim 11, wherein the second angle is 135.6 degrees.

This further specifies the construction of the structure. The channel bisects two adjacent channels and is therefore intended to be arranged in the middle of two adjacent tips. This may further increase the usefulness of the channel for easy replacement of the structure.

In some optional examples, the adjacent tips in the plurality of tips other than the two adjacent tips on either side of the channel may be separated by a third angle measured between adjacent sides of the adjacent tips preferably wherein the third angle is 127.6 degrees.

The construction of the structure is therefore further specified. The aforementioned arrangement of the plurality of tips may be especially effective for removal of pollutants such as methane in use. The specified angle between the tips may also improve structural integrity, and ensure that the tips can be repeatably manufactured to a high degree of precision.

The axial thickness of the structure may be 1 mm in certain useful examples.

The axial thickness of the structure ensures that the structural integrity of the structure is not easily compromised. A minimum axial thickness of 1 mm makes it more difficult to bend the structure out of shape.

### BRIEF DESCRIPTION OF DRAWINGS

Example structures for electric field intensification are described in detail herein in reference to the accompanying drawings, in which:

FIG. 1a shows a uniformly distributed charge, i.e. a plasma, in a known discharge device;

FIG. 1b shows a graph which illustrates how plasma density varies across the length of the discharge device shown in FIG. 1a;

FIG. 1c shows a graph which illustrates how the concentration of active species and the concentration of pollutant varies across the length of the discharge device shown in FIG. 1a;

FIG. 2a shows an example staged discharge device including the electric field intensifying structure according to examples of the present disclosure;

FIG. 2b shows a graph which illustrates how plasma density varies across the length of the staged discharge device shown in FIG. 2a;

FIG. 2c shows a graph which illustrates how the concentration of active species and the concentration of pollutant varies across the length of the staged discharge device shown in FIG. 2a;

FIG. 3 shows an example electric field intensifying structure according to an example of the present disclosure;

FIG. 4 shows an example electric field intensifying structure arranged in a discharge device;

FIG. 5 shows an example staged discharge device comprising a plurality of electric field intensifying structures according to an example of the present disclosure;

FIG. 6 shows a chart illustrating how methane abatement varies with operating power of a discharge device when different configurations of the first electrode are used;

FIG. 7 shows a chart illustrating how methane abatement efficiency varies with operating power in a discharge device where 14 electric field intensifying structures with varying numbers of tips are used; and

FIG. 8 shows a chart illustrating how methane abatement varies with operating power in a discharge device where electric field intensifying structures with 3 tips and 6 tips are used.

### DETAILED DESCRIPTION

The present disclosure provides an electric field intensifying structure for use in a dielectric barrier discharge device. The electric field intensifying structure comprises a ring arranged around a first electrode of the discharge device, and comprises a ring, on which at least one tip is located. The tip limits the minimum distance between the structure and an opposing electrode of the discharge device. By limiting the minimum gap between the structure and the opposing electrode, when an electric field is applied between the two electrodes, an electric breakdown is more likely to occur at this tip.

This provides various advantages in terms of removing pollutants from a gas passing through the discharge device. This will be discussed further with reference to the drawings.

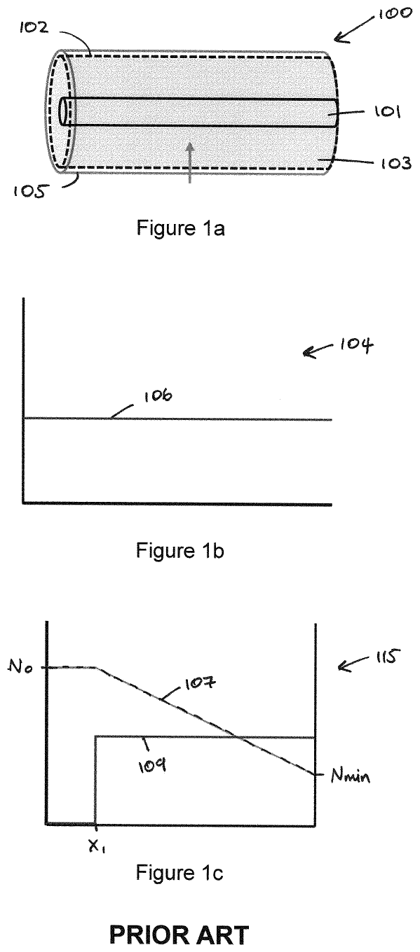

We refer to FIGS. 1a to 1c, which show a known uniformly distributed electrical discharge device 100. The device 100 comprises a first electrode 101, a second, opposing, electrode 105, and a dielectric barrier 102. Between the first electrode 101 and the dielectric barrier 102 is a plasma 103. The plasma 103 is uniformly distributed throughout the device 100, as shown by chart 104 in FIG. 1b. Line 106 represents plasma density across the length of the device 100. An electric field may be applied between the first electrode 101 and the opposing electrode 105.

FIG. 1c shows a chart 115 which illustrates a representation of the concentration of active species in the device 100, indicated by the solid line 109, and the concentration of pollutant, shown by the dashed line 107. The concentration of active species is shown to be negligible until a first location X₁ in the device 100 (i.e., where there is plasma). At location X₁, the concentration of active species steps up to a first concentration, which is constant throughout the rest of the device. As for the concentration of pollutants, it can be seen that the concentration starts at a first concentration N₀, and remains constant until the first location X₁. The concentration of active pollutants then declines, which can be linearly, until some minimum concentration Nₘᵢₙ.

It will be understood that the known discharge device 100 removes pollutants at some constant efficiency.

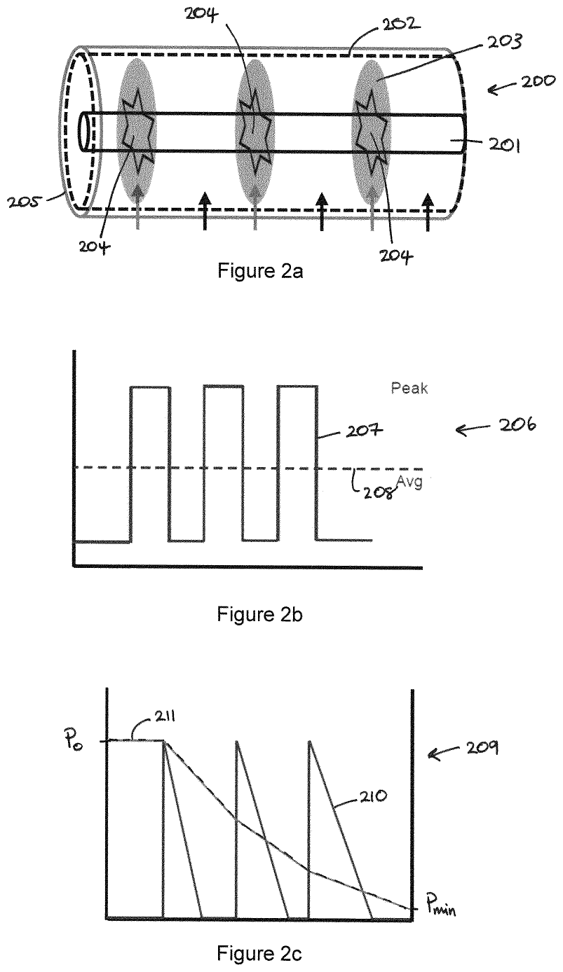

FIG. 2a shows a staged dielectric discharge device 200 comprising a plurality of electric field intensifying structures 204 according to examples of the disclosure. The staged dielectric discharge device 200 further comprises a first electrode 201, a second, opposing, electrode 205, plasma 203 and dielectric barrier 202. An electric field may be applied between the first electrode 201 and the opposing electrode 205.

FIG. 2b shows a chart 206 illustrating plasma density distribution in the staged device 200. The solid line 207 shows the peak plasma density. The solid line shows that the plasma 203 is highly concentrated around each electric field intensifying structure 204 but is only present at low levels in the regions between the structures 204. The dashed line 208 shows the average plasma density in the staged discharge device 200.

FIG. 2c shows a chart 209 illustrating the concentration of active species and concentration of pollutants in the device 200. The solid line 210 represents the concentration of active species, and the dashed line 211 represents the concentration of pollutants. It can be seen that the concentration of active species spikes in the vicinity of each of the structures 204. The concentration of pollutants starts at some initial concentration P₀ and is constant until the first electrifying structure 204 is reached. The concentration of pollutants then decays sharply. After passing through the second and third structures 204, the concentration of pollutants reaches its lowest level of Pₘᵢₙ.

It has been observed that the pollutant removal efficiencies from a staged device, such as the staged device 200, is greater than the pollutant removal efficiencies from a conventional discharge device, such as the device of FIG. 1a. This is hinted at by the fact that with the electrifying structures 204, the pollutants removal efficiencies is greater than that of a conventional device. Further, the concentration of pollutants Pₘᵢₙ is lower that can be achieved by the conventional device Nₘᵢₙ.

We will now describe the electrifying structure in greater detail, and discuss the observations made in support of the efficacy of the electrifying structures.

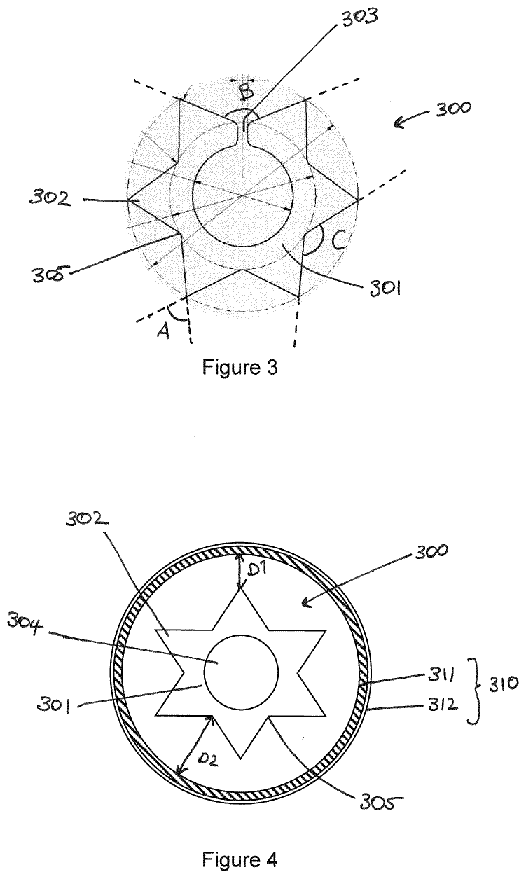

We refer to FIG. 3, which illustrates an example electric field intensifying structure 300. The electric field intensifying structure 300 comprises a ring 301 and at least one tip 302. It will be understood that although six tips are shown in FIG. 3, the structure 300 requires only one tip to operate.

In use, the ring 301 is arranged around a first electrode (not shown). This may be achieved by means of a slot or channel 303 which allows the electric field intensifying structure 300 to be deformed to fit firmly around a first electrode. Other means of arranging the ring 301 around the first electrode are possible. For example, the first electrode may be integral with the structure 300. Such a structure could be formed for example by cutting or milling a material.

It can be seen that the at least one tip 302 extends along a radial axis passing through the centre of the structure 300. In use, the tip 302 limits the minimum distance between the structure 300 and an opposing electrode. That is, the tip 302 effectively creates a region where the distance between the opposing electrode and the structure 300 is smaller than it would be in the absence of the tip 302. In practice, this is can be achieved by using a cylindrical opposing electrode with a dielectric barrier between the structure and the opposing electrode.

Turning now to FIG. 4, an example electric field intensifying structure 300 is shown together with a first electrode 304 and an opposing electrode 310. The ring 301 is arranged around the first electrode 304, and the first electrode 304 has a circular cross section. The first electrode typically has a diameter of 8 mm. The opposing electrode 310 may be formed of a suitable conducting material 312. The conducting material 312 may be formed as a foil. A dielectric material, such as a glass tube 311 may provide a support for the conducting material 312. Further holding means, may be implemented to prevent movement of the conducting material 312 relative to the structure 300. It would be understood that any kind of rigid and impermeable material could be arranged to support the conducting material 312.

FIG. 4 illustrates that the presence of at least one tip 302 limits the minimum gap between the structure 300 and the opposing electrode 310. It can be seen that the distance D1, between the end of the tip and the opposing electrode 310 is smaller than the distance D2 between the opposing electrode 310 and a location on the structure 300 which is devoid of a tip.

In some examples, the size of the distance D1, which is the gap between the sharp point of a tip 302 and the opposing electrode 310, may be 8 mm.

In use, when an electric field is applied between the first electrode 304 and the opposing electrode 310, the probability of electric breakdown occurring at the tip 302 is increased compared at another location between the two electrodes where there is no tip. The electric field strength is concentrated in the immediate vicinity of the tip, which in turn increases the likelihood of electric breakdown occurring. The resulting electrical discharge leads to oxidation of gases, such as pollutants passing through the device.

As discussed about, the electric field intensifying structure 300 provides a technical advantage by facilitating higher production of reactive species to effect pollutant removal. The underlying concept is that an asymmetry has been provided in the applied electric field to encourage electrical breakdown at the tip 302. The inherent geometry of the tip, in that the tip 302 is sharp, is another factor that encourages electric field breakdown at the tip 302.

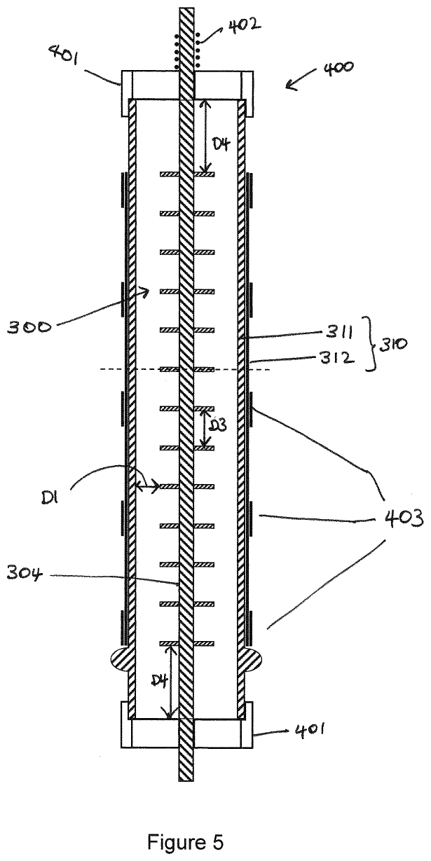

Referring now to FIG. 5, a cross-sectional view of a staged dielectric discharge device 400 is illustrated. The staged dielectric discharge device 400 may also be referred to a staged reactor 400. FIG. 5 shows that the staged reactor 400 comprises the first electrode 304, and the opposing electrode 310 as previously discussed with reference to FIG. 4. The staged reactor 400 further comprises end caps 401 and a compression spring 402. The compression spring 402 ensures that the end caps 401 remain in position, even when thermal expansion or contraction of the first electrode 304 and opposing electrode 310 occurs. The end caps have suitable perforations to allow gas to pass in to and out of the staged reactor 400, but the perforations are not shown. A plurality of constant force springs 403 are also provided. The constant force springs 403 surround circumference of the opposing electrode 310. The constant force springs 403 adhere the conducting material 312 to the dielectric layer 311. This can prevent relative movement between the conducting material 312 and the dielectric barrier 311.

The staged reactor 400 further includes a plurality of the electric field intensifying structures 300 discussed previously. The gap D1 between a tip and the opposing electrode 310 is again shown to provide context. The distance between adjacent structures is some distance D3. However, the distance between the structures adjacent to the end caps 401 may be some other distance D4, different to D3.

Further details of the electric field intensifying structure will now be described with reference to FIG. 3. It has been described that the structure 300 comprises at least one tip 302. In some examples, the structure 300 may instead comprise a plurality of tips 302 arranged on an (radially) outer edge of the ring 301. The plurality of tips could be distributed on the outer ring in any suitable way. However, it may be advantageous for each of the plurality of tips 302 to extend along a respective radial axis. By this we intend to mean that each of the tips 302 extends in a unique radial direction (radial directions separated by 180 degrees of rotation still being considered unique to each other). However, none of the tips 302 will extend along the same radial axis as the channel 303, since the channel 303 creates a break in the material of the ring 301.

A plurality of tips 302 is advantageous in that additional sites for electric breakdown to occur are created, which further increases the production of reactive species. This tends to increase the efficiency of pollutant removal when a gas comprising a pollutant is passed through a staged reactor, such as staged reactor 400 in use. However, as will be discussed below, more tips are not always better for increasing the efficiency of pollutant removal.

It may provide a further advantage for the plurality of tips 302 to be uniformly distributed on the outer edge of the ring 301. By this we intend to mean that the plurality of tips 302 are uniformly distributed on the material of the outer edge of the ring. This may therefore exclude the channel 303. A uniform distribution of tips 302 is effective for ensuring that as much of the gas passing through a discharge device has a chance of being treated. In other words, uniformly distributed tips may overcome issues that arise from tips being crowded together.

The benefit of providing a channel 303 has been discussed above. In short, the channel 303 may allow the structure 300 to be fitted securely on a first electrode in use, and counters issues that may arising due to thermal expansion or contraction. The channel extends from the centre of the ring 301 to the exterior of the ring 301 along a second radial axis. The second radial axis is not aligned with the at least one tip 302. When the structure 300 comprises a plurality of tips, the channel 303 is not aligned with any of the tips' respective axes. That is to say, the channel 303 does not overlap any of the tips.

In an example, the channel 303 may have a width of 1 mm. More preferably, the channel 303 may have a width of 0.8 mm.

As regards the ring 301, in some scenarios, the ring 301 has a main body which the at least one tip 302 is connected to. It follows that in the multi-tip case, each of the tips will be connected to the main body. The main body has a radial thickness, which may be 3.6 mm. More preferably, the radial thickness of the main body of the ring 301 may be 3.56 mm or 3.46 mm. The radial thickness may also have any value in the range between 3.46 mm and 3.56 mm.

Further, the surface of the ring may be continuous. By this, we intend to mean that the material forming the ring is solid, without any gaps passing through the ring in the axial direction. For completeness, in examples where the structure includes a channel, then the channel is separate to the ring and does not form part of the solid surface of the ring.

The radial thickness of the main body may also be expressed as a percentage of the radius from the centre of the ring 301 to the outer edge of the ring. The radial thickness of the main body may account for between 55% to 65% of the radius from the centre of the ring to the outer edge of the ring. A more specific range is the radial thickness of the main body accounts for between 60.2% to 62.2% of the radius of the ring.

The inner diameter of the ring 301 may be 7.9 mm, such as 7.90 mm, and may have a tolerance of negative 0.1 mm, such as 0.10 mm. In combination with the radial thickness of the main body, the main body may then have an outer diameter of 11.5 mm, such as 11.46 mm. Each tip 302 may extend the outer diameter of the ring at the point of each tip to 18.0 mm, such as 18.00 mm. This means that each tip typically has a height in a radial direction between its point and its radial closest point on the main body of the ring of 6.5 mm, such as 6.54 mm. These sizes may vary between examples, but typically the ratios of these dimensions or similar ratios may continue to be applicable.

The structure of the at least one tip 302 will be detailed further. The at least one tip comprises two (typically straight) sides which meet at a point. The point is typically a sharp point. The sharpness of the point may be understood in terms of the angle at which to the two sides meet. The two sides of the at least one tip 302 may meet at a first angle, marked as A in FIG. 3, of 68.9 degrees. More preferably, the first angle may be 68.89 degrees.

It has been discussed that a plurality of tips may be especially effective in neutralising a pollutant. In some examples, the plurality of tips is six tips. The 6 tips may be uniformly distributed, as discussed above.

By stating that the plurality of tips is 6 tips, this could mean that the plurality of tips comprises 6 tips. That is, there are at least 6 tips.

However, other examples are envisioned in which the plurality of tips consists of 6 tips. That is, the ring 301 of structure 300 may have exactly 6 tips, only 6 tips, or 6 tips only.

In examples where the structure 300 includes a plurality of tips and a channel 303, then the second radial axis, that is, the axis along which the channel 303 extends, bisects a second angle being measured between adjacent sides of two adjacent tips on either side of the channel 303. The second angle, marked as B in FIG. 3, is measured between the two adjacent sides of the two adjacent tips. The second angle may be 135.6 degrees, but preferably it is 135.63 degrees.

In the case where the structure 300 comprises a plurality of tips 302, then a third angle measured between adjacent tips, except for the second angle already discussed, is 127.6 degrees. This is shown as angle C in FIG. 3. Preferably, the third angle may be 127.55 degrees.

It is to be noted that the space between adjacent tips 305 is rounded to avoid creating addition breakdown sites. That is, the region 305 between adjacent tips has a radius of curvature, and the radius of curvature may be 0.5 mm. The space between the channel 303 is also rounded for the same reason.

The electric field intensifying structure 300 also has a thickness in the axial direction. The axial thickness may be 1 mm, or preferably 1.0 mm. The competing factors in determining the axial thickness of the structure are structural integrity and manufacturing cost. A 1 mm thick structure meets a requirement of structural integrity without leading to excessive manufacturing costs.

The structure 300 may be made from any material which conducts electricity and can be rigid. The structure 300 may be used at high temperatures, so the material used to form the structures must be able to withstand high temperatures without excessively warping, melting, or changing its electrical properties, i.e., the ability to conduct electricity. A range of materials are suitable, and one such example is stainless steel 316L.

The first electrode 304 and the opposing electrode 310 are also usually formed from, or include, stainless steel. Specifically, the conducting material 312 may be stainless steel sheet.

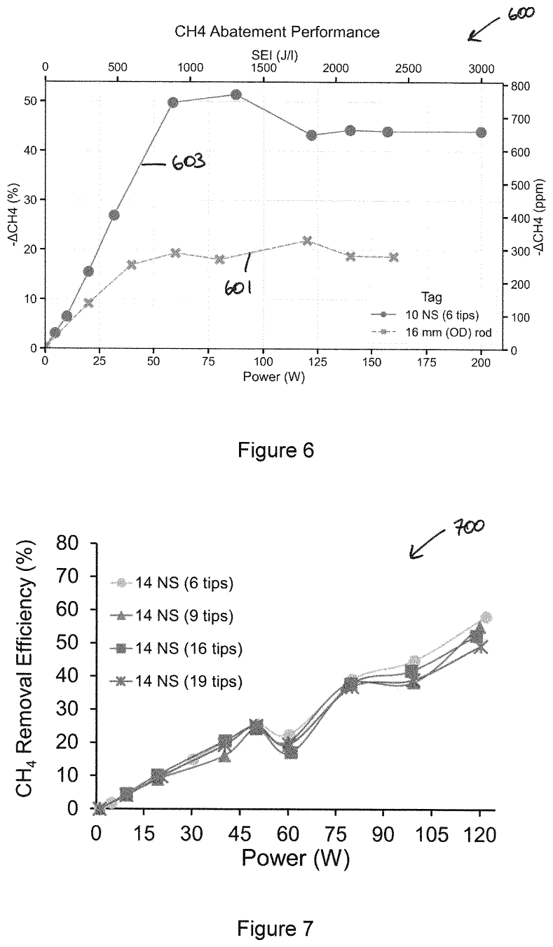

FIGS. 6 to 8 show experimental data relating to different types of electric field intensifying structures. These will now be discussed. It will be learnt that an electric field comprising a tip provides considerable advantages in the treatment of pollutants such as methane. It will also be seen that a structure with 6 uniformly distributed tips is the most effective in treatment of gas to remove methane.

FIG. 6 provides a chart 600 illustrating methane abatement achieved in a discharge device with different configurations. Specifically, graph 600 shows three data sets relating to variations in methane abatement versus power and specific energy input (SEI) for different configurations of the first electrode discussed in relation to FIGS. 4 and 5.

The line 601 marked by crosses shows how methane abatement varies with power when the first electrode is formed as a rod with diameter of 16 mm. It will be noted that this is twice the typical size of diameter of the first electrode as discussed above with relation to FIG. 4, however the size of the gap between the first electrode and opposing electrode is the same as in the configuration with electrode with electric field intensifying structures.

Line 603 shows how methane abatement varies when a discharge device is provided with 10 electric field intensifying structures with 6 tips. It can be seen that the electric field intensifying structures outperform the rod with 16 mm diameter by having a higher methane abatement at the same power and SEI. Chart 600 demonstrates a proof of the concept that the electric field intensifying structures can outperform alternative configurations.

As discussed, the structure 300 requires at least one tip, but may have a plurality of tips. The efficiency of methane removal for variants of the structure with differing numbers of tips is shown by FIG. 7. FIG. 7 shows a chart 700 of how methane abatement efficiency varies with power for electric field intensifying structures with varying numbers of tips between 0 Watts to 120 Watts. In particular, structures with 6, 9, 16 and 19 tips were tested. Notably, the 6 tip variant outperforms all other variants from about 80 Watts and more noticeably from 110 Watts. The 6 tip variant exhibits particularly high efficiency at around 120 Watts.

In sum, FIG. 7 shows that at most operating powers tested, the number of tips the structure has provides little difference to the efficiency of methane abatement, but at powers between 80 Watts and 120 Watts, the 6 tip variant outperforms all other variants.

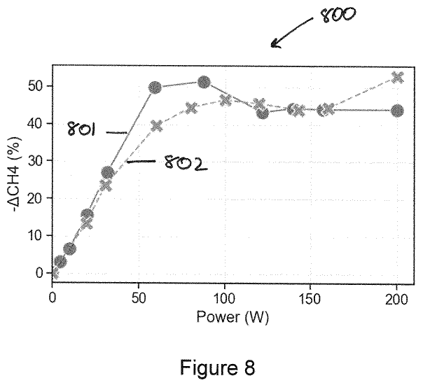

FIG. 8 provides a chart 800 illustrating how methane abatement performance varies with power for structures with 6 tips and structures with 3 tips. It can be seen that the 6 tip variant, represented by line 801, out performs that 3 tip variant, represented by line 802, between 0 Watts and 100 Watts. Between 100 Watts and 160 Watts they perform approximately equally, and between 160 Watts to 200 Watts, the 3 tip variant outperforms the 6 tip variant.

To summarise, we have provided an electric field intensifying structure comprising a ring and at least one tip, which in use is arranged around an electrode of a discharge device to limit the minimum gap between the ring at an opposing electrode. By limiting the gap, the probability of electric breakdown occurring at the gap is increased when an electric field is applied between the first electrode and the opposing electrode. In use, a discharge device comprising at least one such structure may be more effective at removing methane or other pollutants from a as passing through the device than a similar device without the structure.

It is to be understood that the above described electric field intensifying structure may be modified according to design choices and manufacturer's preferences. For example, the number of tips and the width of the ring may be varied according to a design specification. Further, the angle between adjacent sides of a tip, as well as the angle between adjacent sides of adjacent tips may also be adjusted according to a design specification.

The foregoing description of illustrative embodiment has been presented for purposes of illustration and of description. It is not intended to be exhaustive or limiting with respect to the precise form disclosed, and modifications and variations are possible in light of the above teachings or may be acquired from practise of the disclosed embodiments.

1. A structure for electric field intensification for use in a dielectric barrier discharge device, the structure comprising:
a ring including at least one tip, the tip extending along a first radial axis passing through the center of the ring,
wherein in use, the ring is arranged around a first electrode of a discharge device, there being a gap between the structure and an opposing electrode of the discharge device, the at least one tip limiting a minimum gap between the structure and the opposing electrode, thereby increasing a probability of an electric breakdown occurring at the tip when an electric field is applied between the first electrode and the opposing electrode.

2. The electric field intensifying structure of claim 1, further comprising a channel extending from the centre of the ring to the exterior of the ring along a second radial axis, wherein the second radial axis is not aligned with the first radial axis.

3. The electric field intensifying structure of claim 2, wherein a width of the channel is 1 mm.

4. The electric field intensifying structure of claim 1, wherein the ring has a main body, and the at least one tip is connected to the main body.

5. The electric field intensifying structure of claim 4, wherein the main body has a radial thickness of 3.6 mm.

6. The electric field intensifying structure of preceding claim 1, wherein the at least one tip comprises two sides meeting at a point, a first angle being formed between the two sides to form the tip.

7. The electric field intensifying structure of claim 6, wherein the first angle is approximately 68.9 degrees.

8. The electric field intensifying structure of claim 1, wherein the at least one tip comprises a plurality of tips, each tip in the plurality of tips being arranged on the outer edge of the ring.

9. The electric field intensifying structure of claim 8, further comprising a channel extending from the center of the ring to the exterior of the ring along a second radial axis, wherein the second radial axis is not aligned with the first radial axis, and
wherein the plurality of tips each extend along a respective radial axis not aligned with the second radial axis.

10. The electric field intensifying structure of claim 8, wherein the plurality of tips are uniformly distributed on the outer edge of the ring.

11. The electric field intensifying structure of claim 8, wherein the plurality of tips comprises 6 tips.

12. The electric field intensifying structure of claim 11, wherein the plurality of tips consists of 6 tips.

13. The electric field intensifying structure of claim 11, further comprising a channel extending from the center of the ring to the exterior of the ring along a second radial axis, wherein the second radial axis is not aligned with the first radial axis, and
wherein the second radial axis bisects a second angle between two adjacent tips on either side of the channel, the first angle being measured between adjacent sides of the two tips.

14. The electric field intensifying structure of claim 13, wherein the second angle is 135.6 degrees.

15. The electric field intensifying structure of claim 8, wherein adjacent tips in the plurality of tips other than two adjacent tips on either side of the channel are separated by a third angle measured between adjacent sides of the adjacent tips preferably wherein the third angle is 127.6 degrees.

16. The electric field intensifying structure of claim 1, wherein the axial thickness of the structure is 1 mm.

17. The electric field intensifying structure of claim 1, wherein a surface of the ring is continuous.

18. The electric field intensifying structure of claim 9, wherein a width of the channel is 1 mm.

19. The electric field intensifying structure of claim 13, wherein a width of the channel is 1 mm.
